(19) United States
(12) Patent Application Publication
(10) Pub. No.: US 2021/0166723 A1
(43) Pub. Date: Jun. 3, 2021

(54) SOUND PLAYING METHOD, TERMINAL, AND STORAGE MEDIUM

(71) Applicant: ZTE CORPORATION, Shenzhen, Guangdong (CN)

(72) Inventor: Lu FENG, Shenzhen, Guangdong (CN)

(21) Appl. No.: 16/636,310

(22) PCT Filed: Sep. 21, 2017
(86) PCT No.: PCT/CN2017/102760

§ 371 Date: Feb. 3, 2020

(30) Foreign Application Priority Data
Aug. 3, 2017 (CN) 201710657065.7

(51) Int. Cl. G10L 25/78; G10L 25/48; G06K 9/46; G06K 9/00

(52) U.S. Cl. CPC G10L 25/78; G06K 9/00362; G06K 9/4661; G10L 25/48

(57) ABSTRACT

A sound playing method includes identifying a target loudspeaker module during a process of playing sound; and playing sound by using the target loudspeaker module. A terminal is further provided. The present disclosure may automatically switch between receivers or the loudspeakers, and therefore, improves user experience. A storage medium stores the above sound playing method.

### TECHNICAL FIELD

The present disclosure relates to, but is not limited to, the field of communication technology, and in particular, to a sound playing method, a terminal, and a storage medium.

### BACKGROUND

Dual-screen mobile phone is not a new concept, since there are dual-screen flip phones among the earliest flip phones. With continuous development and innovation of smart phones, the dual-screen mobile phones have more and more powerful functions, are not limited to one large screen and one small screen, but can have two screens which are the same in size and material, can simultaneously display different pictures, and can be folded and joined to form a whole screen for use.

However, the related dual-screen mobile phones are still designed with an idea of one main screen and one auxiliary screen. In most cases, the main screen is used by default, and the auxiliary screen is only turned on to cooperate with the main screen when needed. Although the auxiliary screen can display independently, the main screen and the auxiliary screen cannot be completely interchanged with each other in terms of functions. The existing dual-screen mobile phones have problems of poor communication effects and poor user experience due to restriction of hardware components or other factors.

### SUMMARY

Embodiments of the present disclosure provide a sound playing method, a terminal and a storage medium, in order to improve user experience.

A sound playing method applicable to a terminal with dual screens and multiple loudspeaker modules includes: identifying a target loudspeaker module during a process of playing sound; and playing sound by using the target loudspeaker module.

Optionally, the step of identifying the target loudspeaker module during the process of playing sound includes: identifying the target loudspeaker module when an event which triggers playing of sound is received.

Optionally, the event which triggers playing of sound includes any one of receiving an incoming call, triggering a call, or opening a sound playing application.

Optionally, the step of identifying a target loudspeaker module includes: identifying a target screen, and determining a loudspeaker module on the target screen to be the target loudspeaker module.

Optionally, the step of identifying the target screen includes at least one of: identifying the target screen according to sensed brightness; identifying a screen facing upwards as the target screen through an acceleration sensor; identifying a currently used screen as the target screen; determining a screen in which a human head is detected within a specified distance to be the target screen; when it is detected that a screen is failed down, determining a screen which is not failed down to be the target screen; or in a case where the target screen cannot be identified, determining a main screen as a target screen by default.

Optionally, the loudspeaker module includes a receiver and/or a loudspeaker.

Optionally, each screen of the terminal is provided with a receiver and/or a loudspeaker.

A terminal with dual screens and multiple loudspeaker modules includes: an identification module configured to identify a target loudspeaker module during a process of playing sound; and a processing module configured to play sound by using the target loudspeaker module.

Optionally, the identifying of the target loudspeaker module during a process of playing sound by the identification module includes identifying the target loudspeaker module when an event which triggers playing of sound is received; and the event which triggers playing of sound includes any one of receiving an incoming call, triggering a call, or opening a sound playing application.

Optionally, the identifying of the target loudspeaker module by the identification module includes identifying a target screen, and determining a loudspeaker module on the target screen to be the target loudspeaker module.

Optionally, the identifying of the target screen by the identification module includes at least one of: identifying the target screen according to sensed brightness; identifying a screen facing upwards as the target screen through an acceleration sensor; identifying a currently used screen as the target screen; determining a screen in which a human head is detected within a specified distance to be the target screen; when it is detected that a screen is failed down, determining a screen which is not failed down to be the target screen; or in a case where the target screen cannot be identified, determining a main screen as the target screen by default.

Optionally, the loudspeaker module includes a receiver and/or a loudspeaker, and each screen of the terminal is provided with a receiver and/or a loudspeaker.

A terminal with dual screens and multiple loudspeaker modules includes a memory, a processor and computer programs stored in the memory, when the computer programs are executed by the processor, the processor performs the following steps: identifying a target loudspeaker module during a process of playing sound; and playing sound by using the target loudspeaker module.

To sum up, with the sound playing method and the terminals according to the embodiments of the present disclosure, receivers or loudspeakers can be automatically switched, and user experience can be improved.

According to an optional embodiment, a storage medium is further provided, and the storage medium can store executable instructions which, when executed by a processor, cause the processor to perform the sound playing method according to the above embodiments.

### BRIEF DESCRIPTION OF THE DRAWINGS

FIG. 1 is a flowchart of a sound playing method according to an embodiment of the present disclosure;

FIG. 2 is a hardware block diagram of a terminal according to an embodiment of the present disclosure;

FIG. 3 is a schematic diagram of two screens of a terminal according to an embodiment of the disclosure;

FIG. 4 is a flowchart of a call processing method according to an embodiment of the present disclosure; and

FIG. 5 is a schematic diagram of a terminal according to an embodiment of the disclosure.

### DETAILED DESCRIPTION

To make objectives, technical solutions and advantages of the present disclosure more apparent, embodiments of the present disclosure will be described in detail below with reference to accompanying drawings. It should be noted that the embodiments of the present disclosure and features of the embodiments may be arbitrarily combined with each other if no conflicts incur.

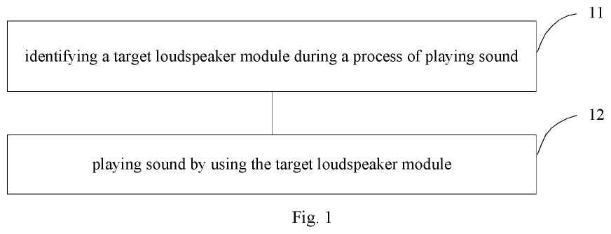

FIG. 1 is a flowchart of a sound playing method according to an embodiment of the present disclosure. As shown in FIG. 1, the sound playing method according to the embodiment is applicable for a terminal with dual screens and multiple loudspeaker modules, and includes the following steps 11 and 12.

In step 11, a target loudspeaker module is identified during a process of playing sound.

In step 12, sound is played by using the target loudspeaker module.

In the embodiment, the loudspeaker module may include a receiver and/or a loudspeaker; and the dual-screen terminal may be a double-sided bar dual-screen terminal or a foldable dual-screen terminal, with both screens capable of functioning as touch screens and each screen provided with a receiver. The dual-screen terminal is mainly applied in a call scenario, including calling and answering, and can automatically select a receiver on a front side or a receiver on a back side as required to make a call.

The dual-screen terminal in the embodiment may also has a loudspeaker mounted on each screen, and is mainly applied in application scenarios such as making calls, playing video, or playing music.

The dual-screen terminal in the embodiment may also have a receiver and a loudspeaker mounted on each screen.

Thus, a target receiver or a target loudspeaker can be intelligently selected according to an actual scenario based on the method according to the embodiment, which improves user experience.

In an embodiment, by identifying a target screen, a loudspeaker module on the target screen may be determined to be the target loudspeaker module.

In an embodiment, the target loudspeaker module may be identified when the terminal receives an event which triggers the playing of sound, and the event which triggers the playing of sound may include receiving an incoming call, triggering a call, opening a sound playing application or the like.

In general, triggering a call and opening a sound playing application are actively performed by a user, and therefore, a receiver or a loudspeaker on a screen currently operated by the user can be selected to play sound in the two scenarios including triggering of a call and opening of a sound playing application.

When an incoming call is received, a target receiver or a target loudspeaker may be identified in the following scenarios.

A. If the terminal is being used, a receiver or a loudspeaker on a screen currently operated by the user is selected to play sound.

B. If the terminal is in a sleep state, for example, the terminal is put on a desk, when an incoming call is received, if both screens of the terminal are provided with light sensor modules, a target screen can be identified according to sensed brightness of two screens, the sensed brightness of a screen facing upwards is greater than that of a screen facing downwards, and the screen facing upwards can be determined to be the target screen. Considering that the terminal may be covered by other objects and thus it is hard to determine which screen faces upwards according to the sensed brightness, an acceleration sensor may be used to identify the screen facing upwards as the target screen.

C. For example, when the terminal in a sleep state is put in a pocket and it is impossible to determine a specific orientation of the terminal, a main screen can be selected by default to display, and a receiver or a loudspeaker on the main screen is used for playing sound.

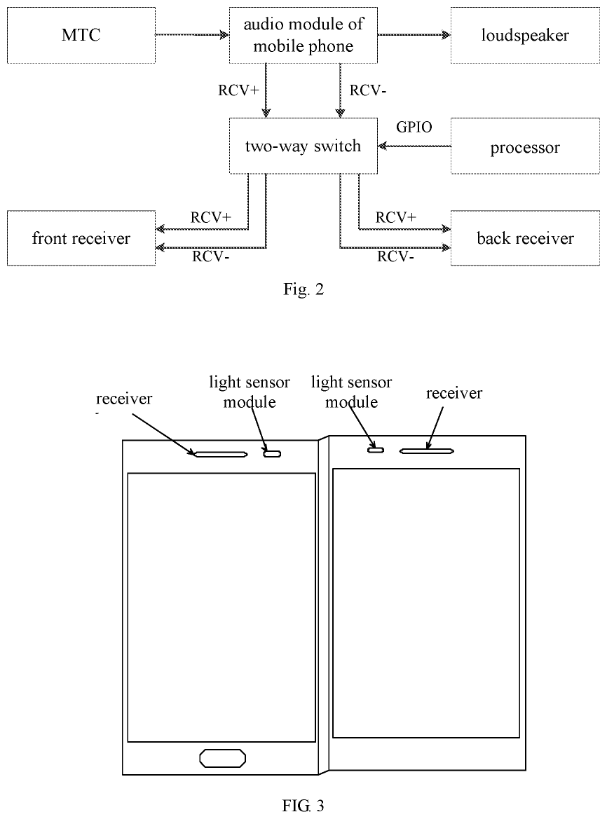

A hardware block diagram of a dual-screen and dual-receiver terminal according to an embodiment of the present disclosure is shown in FIG. 2. Modules required for a terminal to make a call mainly include an audio processing module (generally integrated in a power management chip), a loudspeaker, a microphone (MIC), and a receiver. A common dual-screen mobile phone only has a front receiver; in the embodiment, a back receiver is further added in addition to the original hardware, and a two-way controllable switch is added between the audio module and the receivers, so as to select one of the front receiver or the back receiver to work under the control of a central processing unit (CPU). Since a receiver is usually put close to an ear, in consideration of privacy and security of a call, only the receiver close to the ear needs to work and simultaneous work of both receives is unnecessary, it is more practical to select only one receiver to work, which can also reduce power consumption of the mobile phone.

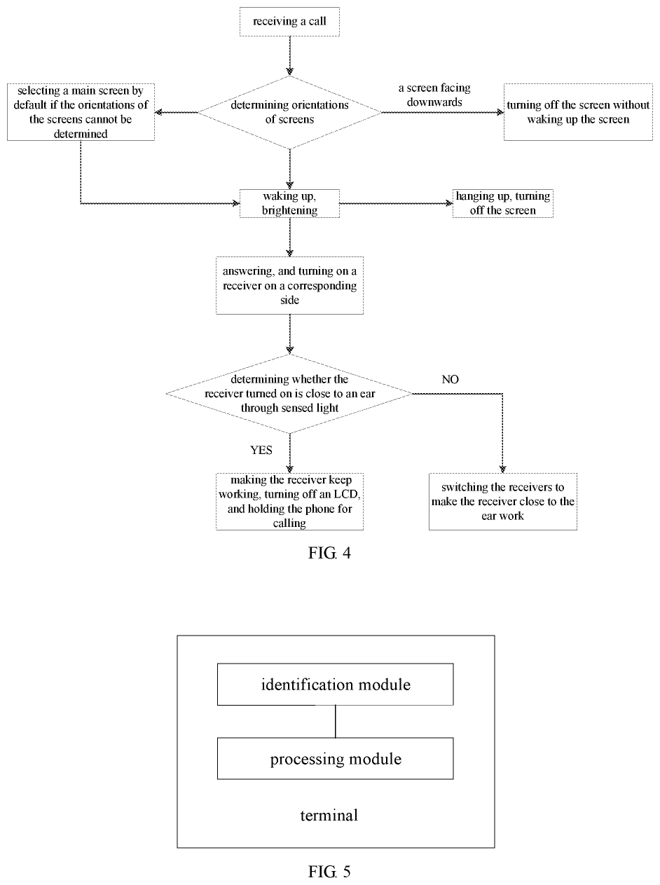

Taking receiving a call as an example, a process of determining a target receiver by identifying a target screen will be described below in detail, as shown in FIG. 4, the process includes the following steps 101 to 106.

In step 101, a call is received.

In step 102, orientations of screens of a terminal are determined to determine a screen facing upwards to be a target screen.

When an incoming call is received, which screen to be used for displaying should be first determined. If a user is using a mobile phone, a currently used screen is used for displaying the incoming call; if the mobile phone is in a sleep state, for example, the mobile phone is put on a desk, a screen facing upwards is selected for displaying the incoming call, so as to allow the user to directly see who is calling. The screen facing upwards is woken up and brightened, while a screen facing downwards is turned off and is not woken up.

In the embodiment, determination of the target screen may be performed solely through an acceleration sensor or a light sensor module in the terminal, or through a combination of the acceleration sensor and the light sensor module.

Values of a Z axis of the acceleration sensor read when a main screen of the terminal faces upwards and downwards are opposite. For example, when the main screen faces upwards, the value of the acceleration sensor is (0, 0, 10), but when the main screen faces downwards, the value of the acceleration sensor is (0, 0, −10). A threshold may be set for the Z axis to determine the orientations of the mobile phone, for example, when the value of the Z axis is greater than or equal to 3, it is determined that the main screen faces upwards.

Alternatively, if both screens of the terminal are provided with light sensor modules, as shown in FIG. 3, the light sensor modules on the two screens can be used to sense brightness respectively. In general, sensed brightness of the screen facing upwards is greater than that of the screen facing downwards.

In step 103, the target screen to be brightened is brightened normally after the target screen is determined, a receiver on a side corresponding to the target screen is turned on, and a screen on the other side is kept in a sleep state.

If the user answers the call, the terminal chooses to turn on the receiver on the side of the screen which is brightened, so that the receiver plays sound. If the user hangs up the phone, the screen enters a sleep state.

In step 104, during a calling process, the screens on the two sides of the terminal may identify a human head when the user puts the mobile phone close to an ear, and when a screen detects a human head within a specified distance range, it is determined whether the screen is a screen on which the receiver which is turned on is located, if yes, step 105 is performed; and if not, step 106 is performed.

When a receiver is used to make a call, it is hard to hear clearly if the mobile phone is held too far away from the ear, and therefore, switching of receivers is performed after detecting a human head within a specified distance range.

In step 105, the receiver which is turning on keeps working, and the screen is turned off while making the call.

In step 106, a working receiver is switched to a receiver on the other screen to make the call.

In the above embodiment, the target screen is determined and brightened, and then the receiver on the side of the target screen is turned on. In another embodiment, the target screen is determined and brightened, and then a human head is detected instead of turning on the receiver on the side of the target screen, and the receiver on the side of the screen which detects a human head within the specified distance range is turned on.

In the above embodiments, illustration is given by an example that the target receiver is determined by identifying the target screen; in other embodiments, illustration may be given by an example that a target loudspeaker is determined by identifying a target screen, which involves the same operation principle, and thus will not be repeated herein.

Of course, during a process of playing music or video, it is possible to determine a target screen by identifying orientations of screens or by identifying a human head, and then perform switching of loudspeakers.

In an embodiment, if a screen of the terminal is broken and failed down, and the terminal detects the broken screen during a process of making a call, playing music or playing video, a screen which is not broken is determined to be the target screen, and a receiver or loudspeaker on the side of the screen which is not broken is selected to play sound.

With the method according to the embodiments, both sides of the dual-screen terminal can perform functions of making a call and playing sound, and a working screen may be switch to the auxiliary screen to operate if the main screen is damaged, which facilitates making a call. In the cases such as that the terminal is put on a desk, an incoming call can be directly displayed, operated and answered through the screen facing upwards, which facilitates operations of the user; and both screens can be switched to display, make a call, and play sound, which improves user experience.

FIG. 5 is a schematic diagram of a terminal with dual screens and multiple loudspeaker modules according to an embodiment of the present disclosure, as shown in FIG. 5, the terminal according to the embodiment includes the following modules.

An identification module is configured to identify a target loudspeaker module during a process of playing sound.

A processing module is configured to play sound by using the target loudspeaker module.

In one embodiment, the identifying of the target loudspeaker module during the process of playing sound by the identification module includes identifying the target loudspeaker module when an event which triggers the playing of sound is received.

The event which triggers the playing of sound includes any one of receiving an incoming call, triggering a call or opening a sound playing application.

In one embodiment, the identifying of the target loudspeaker module by the identification module includes identifying the target screen, and determining a loudspeaker module on the target screen to be a target loudspeaker module.

In one embodiment, the identifying of the target screen by the identification module includes identifying the target screen according to sensed brightness; or identifying a screen facing upwards as the target screen through an acceleration sensor; or identifying a currently used screen as the target screen; or determining a screen which detects a human head within a specified distance to be the target screen; or, when it is detected that a screen is failed down, determining a screen which is not failed down to be the target screen; or, in cases that a target screen cannot be identified, determining a main screen as the target screen by default.

In one embodiment, the loudspeaker module includes a receiver and/or a loudspeaker, and each screen of the terminal is provided with a receiver and/or a loudspeaker.

The terminal according to the embodiment may make a call and play sound on both screens, which improves user experience.

According to the embodiment, a terminal with dual screens and multiple loudspeaker modules is further provided. The terminal includes a memory, a processor and computer programs stored in the memory and capable of being executed by the processor, wherein the processor performs the following steps when executing the programs.

A target loudspeaker module is identified during a process of playing sound.

Sound is played by the target loudspeaker module.

According to an embodiment of the present disclosure, a storage medium is further provided. In the embodiment, the storage medium is configured to store program codes for performing the following steps S1 and S2.

In S1, a target loudspeaker module is identified during a process of playing sound.

In S2, sound is played by using the target loudspeaker module.

The storage medium is further configured to store program codes for performing the following step S1.

In S1, the target loudspeaker module is identified when an event which triggers the playing of sound is received.

The storage medium is further configured to store program codes for performing the following step S1.

In S1, the target loudspeaker module is identified when an event including any one of receiving an incoming call, triggering a call or opening a sound playing application is received.

The storage medium is further configured to store program codes for performing the following step S1.

In S1, a target screen is identified to determine a loudspeaker module on the target screen to be the target loudspeaker module.

The storage medium is further configured to store program codes for performing one of the following steps S1 to S6.

In, S1, the target screen is identified according to sensed brightness.

In S2, a screen facing upwards is identified as the target screen through an acceleration sensor.

In S3, a currently used screen is identified as the target screen.

In S4, a screen in which a human head is detected within a specified distance is determined to be the target screen.

In S5, when it is detected that a screen is failed down, a screen which is failed down is determined as the target screen.

In S6, in a case where a target screen cannot be identified, a main screen is determined as the target screen by default.

It should be understood by those skilled in the art that all or part of the steps of the above methods may be implemented by instructing relevant hardware with programs, and the programs may be stored in a computer-readable storage medium, such as a read-only memory, a magnetic disk or an optical disc. All or part of the steps in the above embodiments may also be implemented by using one or more integrated circuits. Accordingly, each module/unit in the above embodiments may be implemented in the form of hardware, or in the form of a software functional module. The present disclosure is not limited to any specific form of combinations of hardware and software.

The above embodiments are merely optional embodiments of the present disclosure, and there may be other embodiments of the present disclosure. Without departing from the spirit and essence of the present disclosure, various corresponding changes and modifications can be made by those skilled in the art according to the present disclosure, and should be considered to fall within the protection scope of the claims of the present disclosure.

### INDUSTRIAL APPLICABILITY

By identifying a target loudspeaker module and playing sound by the target loudspeaker module during a process of playing sound, receivers or loudspeakers can be automatically switched, and user experience is improved.

1. A sound playing method applicable to a terminal with dual screens and multiple loudspeaker modules, comprising:
identifying a target loudspeaker module during a process of playing sound; and
playing sound by using the target loudspeaker module.

2. The method of claim 1, wherein the step of identifying the target loudspeaker module during the process of playing sound comprises:
identifying the target loudspeaker module when an event which triggers playing of sound is received.

3. The method of claim 2, wherein the event which triggers playing of sound comprises any one of:
receiving an incoming call, triggering a call, or opening a sound playing application.

4. The method of claim 1, wherein the step of identifying the target loudspeaker module comprises:
identifying a target screen; and
determining a loudspeaker module on the target screen to be the target loudspeaker module.

5. The method of claim 4, wherein the step of identifying the target screen comprises at least one of:
identifying the target screen according to sensed brightness;
identifying a screen facing upwards as the target screen through an acceleration sensor;
identifying a currently used screen as the target screen;
determining a screen in which a human head is detected within a specified distance to be the target screen;
when it is detected that a screen is failed down, determining a screen which is not failed down to be the target screen; or
in a case where the target screen cannot be identified, determining a main screen as a target screen by default.

6. The method of claim 1, wherein the loudspeaker module comprises:
a receiver and/or a loudspeaker.

7. The method of claim 6, wherein
each screen of the terminal is provided with a receiver and/or a loudspeaker.

8. A terminal with dual screens and multiple loudspeaker modules, comprising:
an identification module configured to identify a target loudspeaker module during a process of playing sound; and
a processing module configured to play sound by using the target loudspeaker module.

9. The terminal of claim 8, wherein
the identifying of the target loudspeaker module during the process of playing sound by the identification module comprises identifying the target loudspeaker module when an event which triggers playing of sound is received, and
the event which triggers playing of sound comprises any one of receiving an incoming call, triggering a call, or opening a sound playing application.

10. The terminal of claim 8, wherein
the identifying of the target loudspeaker module by the identification module comprises identifying a target screen, and determining a loudspeaker module on the target screen to be the target loudspeaker module.

11. The terminal of claim 10, wherein
the identifying of the target screen by the identification module comprises at least one of:
identifying the target screen according to sensed brightness;
identifying a screen facing upwards as the target screen through an acceleration sensor;
identifying a currently used screen as the target screen;
determining a screen in which a human head is detected within a specified distance to be the target screen;
when it is detected that a screen is failed down, determining a screen which is not failed down to be the target screen; or
in a case where the target screen cannot be identified, determining a main screen as a target screen by default.

12. The terminal of claim 8, wherein
the loudspeaker module comprises a receiver and/or a loudspeaker, and each screen of the terminal is provided with a receiver and/or a loudspeaker.

13. A terminal with dual screens and multiple loudspeaker modules, comprising a memory, a processor and computer programs stored in the memory, when the computer programs are executed by the processor, the processor performs the following steps:
identifying a target loudspeaker module during a process of playing sound; and
playing sound by using the target loudspeaker module.

14. A storage medium, comprising stored programs which, when executed by a processor, cause the processor to perform the method of claim 1.
